(19) United States
(12) Patent Application Publication
(10) Pub. No.: US 2026/0348290 A1
(43) Pub. Date: Nov. 5, 2026

(54) STATOR MEMBER FOR A TURBINE ENGINE, EQUIPPED WITH AT LEAST ONE FIN, AND METHOD FOR MOUNTING AT LEAST ONE FIN IN THE STATOR MEMBER

(71) Applicant: SAFRAN, Paris (FR)

(72) Inventors: William Henri Joseph Riera, Moissy-Cramayel (FR); Simon Pierre Michel Martin, Moissy-Cramayel (FR); Gabriel Perez, Moissy-Cramayel (FR)

(73) Assignee: SAFRAN, Paris (FR)

(21) Appl. No.: 19/473,102

(22) PCT Filed: Apr. 5, 2024
(86) PCT No.: PCT/FR2024/050447

§ 371 Date: Oct. 6, 2025

(30) Foreign Application Priority Data
Apr. 7, 2023 (FR) FR2303505

(51) Int. Cl. F01D 9/04

(52) U.S. Cl. CPC F01D 9/042; F01D 9/041; F05D 2220/323; F05D 2240/80; F05D 2260/33

(57) ABSTRACT

A stator member includes two circumferentially adjacent stator vanes each having a vane body extending radially from an annular wall centered on the longitudinal axis, the stator member having a fin arranged circumferentially between the two stator vanes. The annular wall includes a recess open onto a radially outer surface of the annular wall and at a distance from the upstream and downstream edges of the annular wall, the fin having a root with a shape matching the recess configured to be removably arranged in the recess, and a fin body which extends radially from the root and which is elongate in a direction of elongation substantially parallel to the longitudinal axis.

### TECHNICAL FIELD OF THE INVENTION

The present invention relates to the field of turbine engines, in particular an aircraft, in which air flows from upstream to downstream. More specifically, but not exclusively, it relates to a stator member of a turbine engine comprising stator vanes and at least one fin. It also covers a method for mounting at least one fin in the stator member.

### TECHNICAL BACKGROUND

An aircraft turbine engine may be equipped with one or more stator members, such as a stator vane stage of a compressor or turbine. The turbines and compressors generally comprise several stages of stator vanes and movable vanes that alternate along the longitudinal axis of the turbine engine. The stator vanes extend radially between two radially internal and external walls. A flow of air passes through the compressors and turbines, circulating between the various stages of stator vanes and movable vanes. The stator vanes allow the air flow to be straightened downstream of the movable vanes. However, vortices are generated at the radially internal wall when the air flow interacts with the stator vanes. The vortices create friction losses and can also cause aerodynamic separation if they strike the suction side of the stator vanes.

Fins have been placed between adjacent stator vanes to reduce or even eliminate these vortices. These fins are generally smaller than the stator vanes. There are several examples of fins such as those described in the patent documents US-A1-2018/017079, FR-B1-3106614, FR1854134, and FR3081185. However, the arrangement of these fins in the stator members appears to be complex for the most part in relation to the radially inner wall for example and the fins do not appear to be easy to fit and/or remove in the event of maintenance without dismantling the stator member and/or the whole module. The geometry of some of the fins, which are very thin, can wear out quickly and require regular replacement. On the other hand, these fins can be mounted on platforms which have complex holding means on the radially internal wall and which can give rise to disturbances in the air flow. Added to this is the fact that the shape of the fins may not be suited to the performance or mission sought, and it is impossible to remedy this problem of shape. These disadvantages are detrimental to the performance of the turbine engine.

There is a need to resolve some or all of the aforementioned drawbacks.

### SUMMARY OF THE INVENTION

The objective of the present invention is to provide a simple, cost-effective and robust solution that enables a fin to be safely and efficiently integrated into a stator member.

This is achieved in accordance with the invention by means of a stator member of a turbine engine, in particular an aircraft, extending around a longitudinal axis, the stator member comprising at least one first stator vane and at least one second stator vane which are circumferentially adjacent, the first and second stator vanes each comprising a blade extending radially from an annular wall centered on the longitudinal axis, the stator member comprising a fin arranged circumferentially between the first and second stator vanes, the annular wall comprising a recess of predetermined shape formed through its thickness, open onto a radially external surface of the annular wall and spaced from the upstream and downstream edges of the annular wall, the fin comprising a root, complementary in shape to the recess, configured to be removably arranged in the recess, and a fin body which extends radially from the root and which is elongated in a direction substantially parallel to the longitudinal axis.

This solution therefore allows to achieve the above-mentioned objective. In particular, the arrangement of the fins, considered as a passive system, improves the operability of the turbine engine by limiting or even eliminating the flow between two adjacent stator vanes of a stator member. Each fin creates a wall close to the stator vanes which blocks the parietal flow from the pressure side surface of a blade of an adjacent stator vane. The configurations of the recess and the corresponding root shape allow the optimization of the integration of the fin into the annular wall of the stator member and secure it in a simple, quick, and effective manner. Their configurations also allow easy replacement of each fin, for example, under the wing, without having to dismantle the entire module, and in particular the entire stator grid. Fins with different shapes can be designed depending on the tasks to be performed, which allows the system to be optimized and made more flexible. In addition, replacing the fins means cost savings, flexibility in the shape of the fins depending on the performance required and a reduction in environmental impact.

The stator member also comprises one or more of the following characteristics and/or steps, taken alone or in combination:
the root extends along an axis of revolution and comprises a base and a separate platform connected by a rod along the axis of revolution A.
the base has two lugs of identical shape and arranged on either side of the rod in a plane perpendicular to the axis of revolution.
the fin is made from a material or is formed from one-part pieces assembled.
the recess comprises three portions configured to receive respectively one of the elements forming the root.
the recess comprises a first portion having a shape corresponding to that of the platform, the platform having an external surface having surface continuity with the radially external surface of the annular wall.
the recess comprises a second portion and a third portion each having a shape similar to that of the base, the third portion having at least one dimension greater than that of the second portion and of the base.
the fin comprises blocking means for blocking the root in the recess.
The blocking means comprise a locking element arranged in a cavity of the base, the locking element being configured to occupy a locking position and an unlocking position, and an element for retaining the locking element in its locking position, which is arranged in the recess.
the blocking means comprise a return element mounted in the cavity and configured to continuously urge the locking element towards the locking position.
the recess comprises at least one groove configured to receive at least part of the locking element in the unlocking position.
the recess and the root of the fin are configured so that the fin pivots between an inactive position in which the direction of elongation of the fin body is transverse to the longitudinal axis and an active position in which the direction of elongation of the fin body is substantially parallel to the longitudinal axis.
the second portion of the recess opens into both the first portion of the recess and the third portion of the recess.

The invention relates to a turbine engine, in particular an aircraft, comprising at least one stator member having any of the aforementioned characteristics.

The invention further relates to a method of mounting at least one fin in a stator member as described above. The method comprises the following steps of:
positioning the root of the fin by complementary shape in the recess and in such a way that the direction of elongation of the fin body is transverse to the longitudinal axis, and
rotating the root of the fin about the axis of revolution A in the recess so as to orientate the direction of elongation of the fin body substantially parallel to the longitudinal axis.

### BRIEF DESCRIPTION OF THE FIGURES

The invention will be better understood, and other purposes, details, characteristics and advantages thereof will become clearer on reading the following detailed explanatory description of embodiments of the invention given by way of purely illustrative and non-limiting examples, with reference to the appended schematic drawings in which:

FIG. 1 is an axial cross-sectional view of an example of a turbine engine to which the invention applies;

FIG. 2 is a detailed perspective view of an example of a stator member comprising stator vanes and fins according to the invention;

FIG. 3 shows a perspective view of an example of a fin configured to be removably integrated into a stator member according to the invention;

FIG. 4 is a perspective view of another embodiment of a fin according to the invention;

FIG. 5 shows an example of a recess made in an annular wall of a stator member according to the invention;

FIG. 6 is a detail view of a portion of the recess shown in FIG. 5;

FIG. 7 is a perspective view of a step in which a fin is inserted into a recess in an annular wall of a stator member according to the invention;

FIG. 8 is a perspective view of a rotation step in which a fin is rotated in the recess as shown in FIG. 7;

FIG. 9 is a perspective view of a fin mounted and fixed between two adjacent stator vanes in accordance with the invention;

FIG. 10 is a partial perspective view of part of a root of the fin in a portion of a recess of an annular wall according to the invention;

FIG. 11 is a cross-sectional view of an example of a fin fixed in a recess formed in an annular wall according to the invention; and

FIG. 12 shows a flow diagram of a method for mounting at least one fin in a stator member according to the invention.

### DETAILED DESCRIPTION OF THE INVENTION

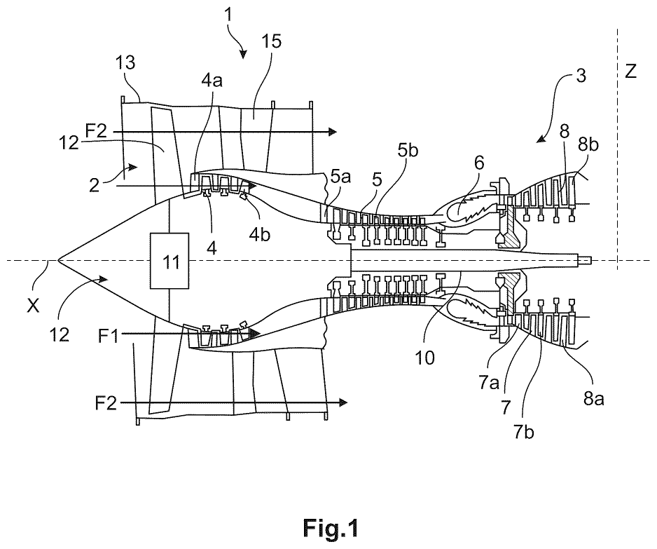

FIG. 1 shows a turbine engine 1 of longitudinal axis X to which the invention applies. The turbine engine 1 is a double-flow, double-body turbomachine configured to be mounted on an aircraft, such as an aeroplane. Of course, the invention can be applied to other types of turbine engine, such as a turbofan, a turboprop or a turboshaft engine, and which may be ducted and unducted.

In the present invention, and in general, the terms “upstream” and “downstream” are defined in relation to the circulation of gases or air flows in the turbine engine and here along the longitudinal axis X. The terms “axial” and “axially” are defined in relation to the longitudinal axis X. The terms “external”, “outer”, “inner”, “internal” and “radial” are defined with respect to a radial axis Z that extends from the longitudinal axis X and with respect to the distance from the longitudinal axis X. The radial axis is perpendicular to the longitudinal axis.

The turbine engine shown comprises a fan 2 mounted upstream of a gas generator 3 or (gas turbine) engine.

The gas generator 3 comprises, from upstream to downstream, a low-pressure compressor 4, a high-pressure compressor 5, a combustion chamber 6, a high-pressure turbine 7 and a low-pressure turbine 8. Typically, the turbine engine 1 comprises a low-pressure shaft (not shown) which connects the low-pressure compressor 4 and the low-pressure turbine 8 to form a low-pressure body, and a high-pressure shaft 10 which connects the high-pressure compressor 5 and the high-pressure turbine 7 to form a high-pressure body. The low-pressure shaft, centered on the longitudinal axis X, is configured to drive a fan shaft (not shown). A power transmission mechanism 11, such as a speed reduction gear, may be interposed between the low-pressure shaft and the fan shaft secured to a hub of the fan 2.

The fan 2 comprises fan vanes 12 carried by the hub of longitudinal axis X and surrounded by a fan casing 13 carrying a nacelle (not shown). The fan 2 compresses the air flow entering the turbine engine 1, which is divided into a primary flow F1 passing through the gas generator and a secondary flow F2 circulating around the gas generator 3.

Each compressor 4, 5 and each turbine 7, 8 comprises several stator stages or stator members comprising stator vanes 4a, 5a, 7a, 8a and several rotor stages comprising movable vanes 4b, 5b, 7b, 8b along the longitudinal axis X. In the present invention, the term “stator vane” or “fixed vane” is taken to mean a vane that is not driven in rotation about the longitudinal axis X of the turbine engine. In other words, this stator vane 4a, 5a, 7a, 8a is distinct from and opposite to a movable or rotor vane 4b, 5b, 7b, 8b of the turbine engine. The stator vanes and movable vanes are arranged in an annular row and the stator vanes stages 4a, 5a, 7a, 8a alternate with the movable vane stages 4b, 5b, 7b, 8b along the longitudinal axis X. The stator vanes 4a, 5a, 7a, 8a deflect and straighten the primary flow F1 at the outlet of each movable vane 4b, 5b, 7b, 8b located upstream of them.

Stator vanes 15 can be arranged downstream of the fan vanes 12 to straighten the secondary flow F2. These stator vanes 15 are known as outlet guide vanes (OGV). The stator vanes 15 are arranged transversely in the nacelle substantially in a plane transverse to the longitudinal axis X. In this example, they are evenly distributed around the axis X of the turbine engine 1.

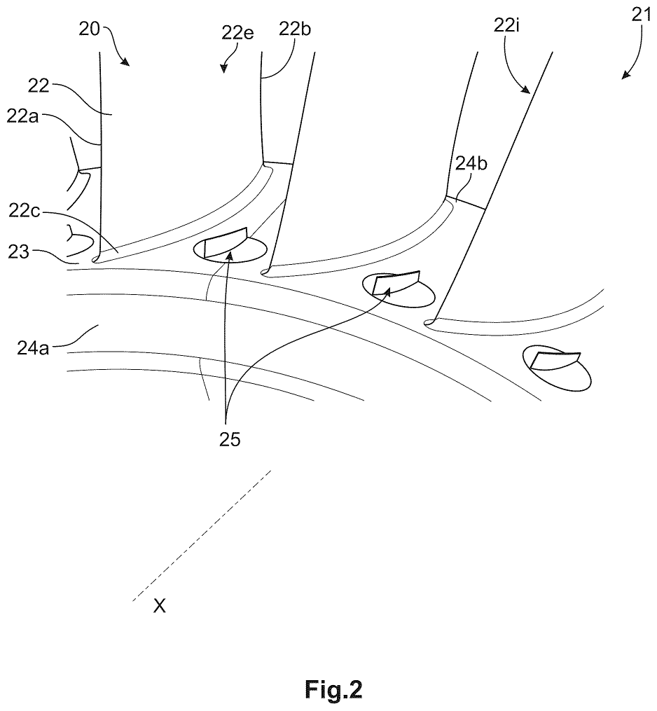

FIG. 2 shows a number of stator vanes 20 fitted to a stator member 21. The stator vanes 20 are distributed circumferentially around the longitudinal axis X. The stator vanes 20 each comprise a blade 22 which extends substantially radially from an annular wall 23 centered on the longitudinal axis X. The annular wall 23 extends between an upstream edge 24a and a downstream edge 24b along the longitudinal axis X. More precisely, the blade 22 extends radially between a radially internal wall and a radially external wall (not shown) which are centered on the longitudinal axis X. The radially internal wall and the radially external wall may be sectorized. In the remainder of the description, we consider that the radially internal wall is the annular wall 23, although the radially external wall could be the annular wall.

Each blade 22 extends radially between a root end 22c and a tip end (not shown). Each blade 22 also comprises a pressure side surface 22i and a suction side surface 22e extending generally axially along the longitudinal axis X and which are connected upstream by a leading edge 22a and downstream by a trailing edge 22b. The pressure side and suction side surfaces are transversely opposite each other. The root end 22c of each blade 22 is attached to the radially internal wall 23. Advantageously, the stator vanes 20 are identical and are arranged longitudinally in the same way along the entire radially internal wall 23. In particular, the radially internal wall 23 and the blades 22 are single parts. In other words, the blade 22 and the radially internal wall 23 (or the radially internal wall sector) are integrally formed.

In FIG. 2, which illustrates an example of a stator member 21, at least one fin 25 is arranged between two circumferentially adjacent stator vanes 20. A plurality of fins 25 are alternated in this embodiment with stator vanes 20 around the longitudinal axis X. The fins 25 are arranged close to the leading edges 22a of the blades 22 of the stator vanes but could be located in any area of the radially internal wall 23 between two adjacent stator vanes 20, 20′.

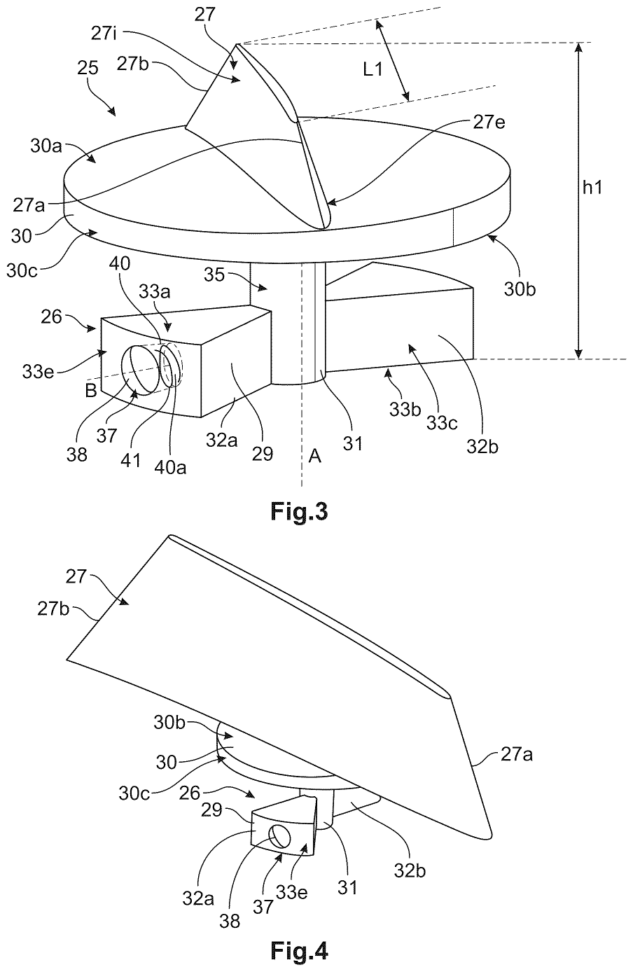

With reference to FIG. 3, each fin 25 comprises a root 26 and a fin body 27 extending radially from the root 26. Each fin 25 has a height h1 typically between 5 and 15% of the height of the stator vanes.

The fin body 27 is elongated in a direction substantially parallel to the longitudinal axis X (in the installation situation). In the example shown, the fin body 27 has an aerodynamic profile substantially identical to that of a stator vane 20. This aerodynamic profile allows, on the one hand, limiting the passage of vortex flow at the radially inner wall 23 and controlling any aerodynamic separation between two adjacent stator vanes 20. Of course, the fin body can have a different shape, such as a rounded shape resembling a hump, a symmetrical shape or a non-axisymmetrical shape. The body of the fin can have various shapes to suit the flow to be controlled and can be more or less steep.

More precisely still, the fin body 27 comprises an upstream edge 27a and a downstream edge 27b which are connected by a suction side surface 27i and an pressure side surface 27e. The fin body 27 has a length L1 measured between the upstream edge 27a and the downstream edge 27b which is less than that of each blade of a stator vane 20. The length L1 can be between 5 and 70% of the length of the blades of the stator vanes. In particular, the length L1 of the fin body 27 must allow the fin 25 to rotate between two stator vanes (between an inactive position and an active position) and this will be detailed later. In the present example, the upstream edge 27a of each fin body 27 is offset downstream of the leading edges 22a of the blades of a stator vane along the longitudinal axis X. This axial offset may be between 0% and 40% of the chord (or chord line) connecting the leading edge 22a to a trailing edge 22b of a blade 22 of a stator vane 20. Alternatively, the upstream edge 27a of each fin body 27 is aligned with the leading edges 22a of the blades of the stator vane 20.

The root 26 is designed to be removably fitted in a recess 28 of predetermined shape formed in the annular wall 23. The root 26 of each fin 25 is complementary in shape to the corresponding recess 28. The fin 25 is therefore configured to be fitted and removably fixed to the stator member 21 and in particular to the radially internal wall 23.

More precisely still, each root 26 extends along an axis of revolution A. Each root 26 comprises a base 29 and a platform 30 which are distinct and which are connected by a rod 31 along the axis of revolution A. In other words, the base 29 and the platform 30 are opposite each other along the axis of revolution A. In the installation situation, the axis of revolution A is parallel to the radial axis Z.

Advantageously, the rod 31 is cylindrical and has a circular cross-section. The fin body 27 is arranged on the platform 30 and extends radially outwards from this platform 30. This latter has a circular cross-section to facilitate integration of the fin 25 into the radially internal wall 23 of the stator member 21. In particular, the platform 30 has an external surface 30a and an internal surface 30b which are opposite each other along the axis of revolution A.

The platform 30 comprises a circular edge 30c connecting the external and internal surfaces 30a, 30b. The fin body 27 rests on the external surface 30a. Advantageously, but without limitation, the upstream edge 27a and the downstream edge 27b of the fin body 27 are contained in the edge 30c of the platform 30. In other words, the fin body 27 extends inside the rim 30c.

In FIG. 4, which represents another embodiment of a fin 25, the fin body 27 which rests on the external surface 30a of the platform 30 extends beyond the rim 30c. In other words, the length L1 of the fin body 27 is greater than the diameter of the platform 30. The root 26 in this embodiment is similar to that in the previous embodiment.

Each base 29 has two lugs 32 of identical shape, referred to as the first lug 32a and the second lug 32b. The lugs 32a, 32b are arranged on either side of the rod 31 in a plane perpendicular to the axis of revolution A of the rod 31. Each lug 32a, 32b has an external surface 33a and an internal surface 33b which are opposite each other along the axis of revolution A. The external and internal surfaces 33a, 33b of the lugs 32a, 32b form the internal and external surfaces of the base 29. Each lug 32a, 32b also comprises two radially extending abutment surfaces 33c, 33d which are joined by a contact surface 33e. The abutment surfaces 33c, 33d are flat and defined in planes transverse to the planes in which the external and internal surfaces 33a, 33b are defined. The internal and external surfaces 33b, 33a are joined by the abutment surfaces 33c, 33d and the contact surface 33e.

In this example, the lugs 32a, 32b have a triangular cross-section. The abutment surfaces 33c, 33d are connected, on the one hand, to the contact surface 33e and, on the other hand, to a cylindrical external surface 35 of the rod 31. Advantageously, but not limited to, the contact surface 33e has a curvature. The latter is defined by a circular arc whose center is located on the axis of revolution A. The abutment surfaces 33c, 33d form a predetermined angle with each other. The predetermined angle can advantageously be between 45° and 80°.

Advantageously, but not limited to, the fin is made of material. In other words, the fin body 27, the platform 30, the rod 31 and the base 29 are formed formed in one-part or from a material. This simplifies the manufacture and installation of the fin. Alternatively, the fin can be formed from a number of one-part pieces, for example the fin body and the root, which are manufactured separately and subsequently assembled using fixing means such as welding, threaded members, adhesive, etc.

Advantageously, but not limited to, the base 29 includes a keying element configured to allow correct assembly of the base in the recess 28 and preferably to differentiate the correct mounting direction. The keying element comprises one of the first and second lugs 32a, 32b of the base 29. One of the first and second lugs 32a, 32b has at least one dimension greater than that of the other of the first and second lugs to form the keying element. In the present example, the first lug 32a extends over an angular section in the plane perpendicular to the axis of revolution A which is greater than the angular section of the second lug 32b. The recess 28 has a portion which has a complementary shape to that of the first lug 32a. As an alternative or in addition, the keying element can of course include at least one pin or other part configured to cooperate with another part or portion formed in the recess 28.

In FIGS. 3 and 4, blocking means 37 are configured to lock the root 26 of a fin 25 in the corresponding recess 28. Preferably, the blocking means 37 are self-locking. By the term self-locking, we mean that locking or unlocking takes place automatically without human intervention or the use of a special additional accessory acting on the blocking means themselves. However, the rotation of the fin is operated by an operator who is not included in this definition. The blocking means 37 comprise a locking element 38 which is movable between a locking position and an unlocking position. In this example, the locking element 38 is carried by the root 26. Alternatively, the locking element 38 is carried by the platform 30 or the rod 31. The blocking means 37 comprise at least one element 39 for retaining the locking element 38 in the locked position.

The locking element 38 is mounted so that it can move in a cavity 40 (shown dotted in FIG. 3) formed in the base 29 of the root 26. However, the locking element 38 projects from the contact surface 33e of the base 29. The cavity 40 is substantially cylindrical along an axis B. The axis B is perpendicular to the axis of revolution A.

The blocking means 37 comprise a return element 41 which is configured to permanently urge the locking element 38 towards the locking position. The return element 41 is mounted in the cavity 40.

The movable locking element 38 comprises a ball, rod, finger or the like. Preferably, the locking element 38 is a ball. The return element 41 is a compression spring. This comprises a first end which is fixed to a bottom 40a of the cavity 40 and a second end which is fixed to the locking element (in this case the ball).

The retaining element 39 is arranged in each recess 28.

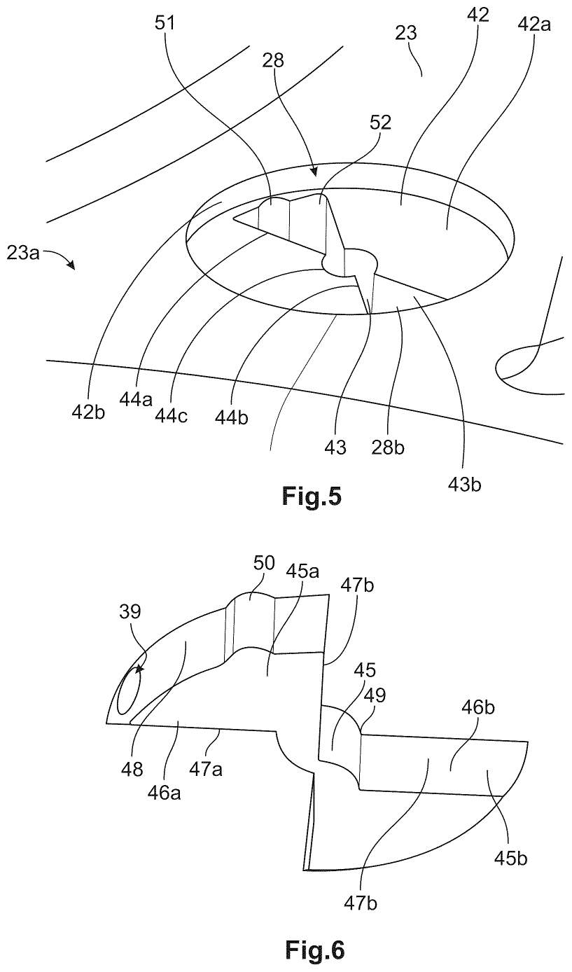

FIG. 5 illustrates more precisely a portion of the radially internal wall 23 which comprises at least one recess 28 formed in the thickness of the wall 23 and which is open on a radially external surface 23a of the wall 23. As can be seen, the recess 28 is advantageously located at a distance from the upstream and downstream edges 24a, 24b of the annular wall. This facilitates the assembly of each fin and avoids parts arranged upstream of the upstream edge 24a of the annular wall or downstream of the downstream edge 24b of the annular wall 23, which could hinder the assembly or disassembly of each fin 25.

The recess 28 has different portions configured to receive the respective elements forming the root 26. The different portions are positioned along the radial axis Z. In other words, the different portions are arranged at different depths in the thickness of the radially internal wall 23.

The recess 28 comprises a first portion 42 which is configured to receive the platform 30 of the root 26. The first portion 42 comprises a shape similar to that of the platform. Here, the platform 30 and the first portion 42 have a circular cross-section and are complementary in shape. The platform 30 and the first portion 42 have the same height (along the radial axis). The first portion 42 comprises a bottom 42a which is defined in a plane perpendicular to the radial axis. A circular wall 42b rises from the bottom 42a (along the radial axis). The height of the first portion 42 is measured from this bottom. When installed, the external surface 30a of the platform 30 has surface continuity with the radially external surface 23a of the radially internal wall 23. The edge 30c of the platform matches the circular wall 42b while allowing the platform 30 to rotate around the axis of revolution A.

The recess 28 also comprises a second portion 43 which has a shape corresponding to that of the base 29. In this example, the second portion 43 is defined by a through opening on either side along the radial axis and delimited by a radial wall 43b. In other words, the second portion 43 opens into the bottom 42a of the first portion 42. More specifically, the second portion 43 has a shape with two parts 44a, 44b which are opposite each other in a direction defined in a plane perpendicular to the radial axis. This shape is very similar to that of an hourglass. The second portion 43 also comprises a central area 44c, the cross-sectional wall of which is in the shape of a semicircle and is complementary to the cylindrical surface 31a of the rod 31. Advantageously, but without limitation, the second portion 43 is the same height as or less than the rod 31. In this example, part 44a of the second portion extends over a larger angular sector than the second part 44b. The first part 44a can accommodate the first lug of the base and the second part can accommodate the second lug of the base 29. This function of the keying elements of the second portion 43 and the lugs of the base 29 allows the root 26 to be inserted into the recess in the correct direction.

With reference to FIG. 6, the recess 26 finally comprises a third portion 45 which also has a shape corresponding to that of the base 29. The third portion 45 comprises a generally hourglass shape like the second portion 43, i.e. two opposing parts in a direction defined in a plane perpendicular to the radial axis. The second portion 43 opens into the third portion 45. The third portion 45 is configured to receive the base 29 when installed. However, the third portion 45 is larger than the second portion 42 and the base 29. This allows the base 29 to rotate in the third portion of the recess 28.

To this end, the third portion 45 has a bottom 45a from which rises a radial wall 45b defining the shape thereof. The bottom 45a is defined in a plane perpendicular to the radial axis. The internal surface 33b of the base 29 is configured to rest on the bottom 45a of the third portion 45 of the recess. In this example, the area of the internal surface 33b of the base is substantially half that of the bottom 45a of the third recess portion 45.

For each part 46a, 46b making up the third portion 45, the radial wall 45b comprises two opposite panels 47a, 47b which are connected by a curvilinear partition 48. The two sections are linked by a central area 49 with semi-cylindrical walls. The opposite panels 47a, 47b of each part form a predetermined angle with each other. The predetermined angle can advantageously be between 50° and 160°.

As previously stated, and as can be seen in FIG. 6, the recess 28 comprises the retaining element 39 of the locking element 38 in its locking position. The retaining element 39 is formed in the curvilinear partition 48. The retaining element 39 is formed here by a housing, the opening of which opens into the curvilinear partition 48 at the level of the third potion 45. The housing here has a circular cross-section.

The recess 28 also comprises at least one groove configured to receive at least part of the locking element 38 in the unlocking position. In particular, a first groove 50 is arranged in the curvilinear partition 47, in the third portion 45. The first groove 50 is complementary to the locking element 38, in this case the ball, which projects from the base 29 in the unlocking position. In particular, the first groove 50 is arranged at a distance from the housing which receives the locking element 38 in the locking position.

A second groove 51 is arranged in a circular partition 52 of the second portion 43 and in particular of one of the parts 44a, 44b (here the first part) of the second portion 43. The second groove 51 is advantageously located in a central area of the partition 51. The second groove 51 is also complementary in shape to the locking element 38, particularly in the unlocking position.

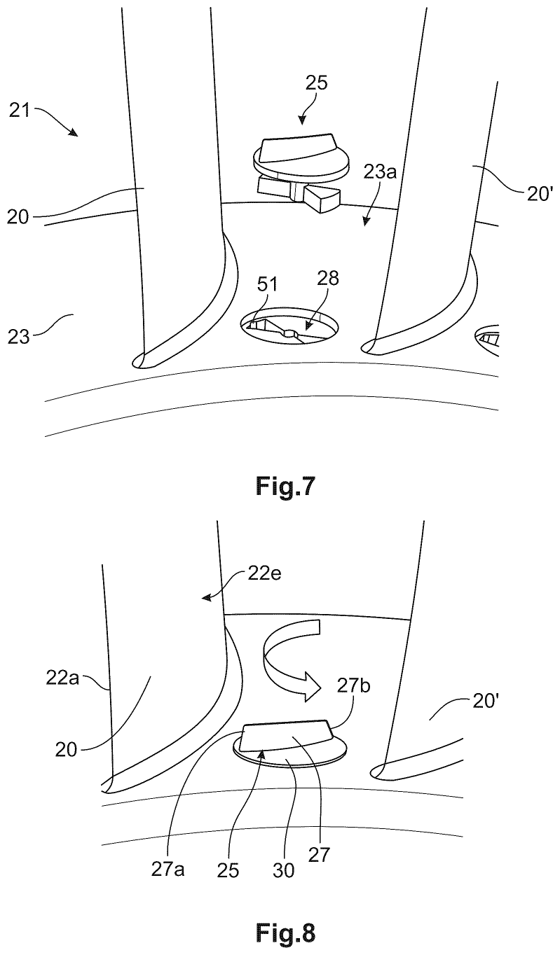

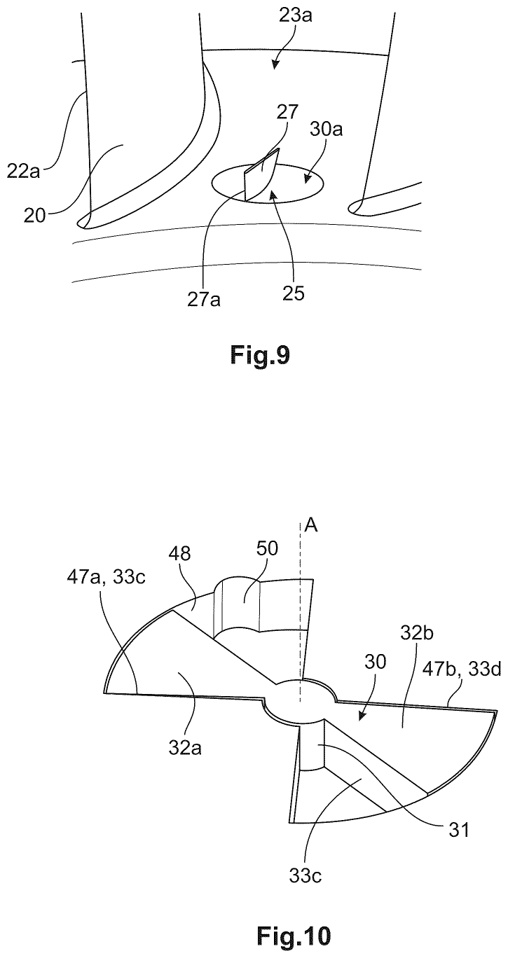

We will now describe in detail the method of mounting at least a fin 25 in a corresponding recess 28 in an annular wall 23 of a stator member 21 of the turbine engine, with the aid of FIGS. 7 to 11. This method is shown in a flow chart in FIG. 12.

The method 100 comprises a step of positioning 101 the root 26 of the fin 25 by complementary shape in the recess 28 of the annular wall 23 of the stator member 21. During this positioning, a translation along the radial axis Z is carried out. The radial translation facilitates assembly and avoids any obstacles to assembly and/or disassembly.

Before the root 26 is positioned in the recess 28, the fin 25 is positioned so that the upstream edge 27a of the fin body 27 is positioned substantially opposite the suction side surface 22e of the blade 22 of the first stator vane 20. In other words, the direction of elongation of the fin body 27 is transverse to the longitudinal axis. This is allowed by the keying elements, which in this case are the difference in size between the lugs 32a, 32b of the base 29 and the second portion 43.

During the positioning, the base 29 passes first through the first portion 42 of the recess, then through the second portion 43 of the recess, to end up in the third portion 45.

After the root 26 has been positioned in the recess 28, the fin 25 is in an inactive position in which the direction of elongation of the fin body 27 is transverse to the longitudinal axis. More specifically, the internal surface 33b of the base 29 is in contact with the bottom 45a of the third recess portion 45 and the internal surface 30b of the platform 30 is in contact with the bottom 42a of the first recess portion 42. The contact surface 33a of each lug 32a, 32b is substantially complementary to the corresponding curvilinear partition 48. The rod 31 extends through the third portion and/or the second portion, particularly in the central areas. The axis of the rod 31 acts as the axis of rotation of the root in the recess 28. The locking element 38 (the ball) of the blocking means 37 is inserted into the first groove 50. The locking element 38 occupies its unlocking position. The external surface 30a of the platform is flush with the radially external surface 23a of the annular wall 23. The platform 30 is arranged in a complementary shape in the first recess portion 42.

The method 100 comprises a step of rotating 102 the root 26 of the fin about the axis of revolution A in the recess 28 so as to orientate the direction of elongation of the fin body 27 substantially parallel to the longitudinal axis X. The direction of elongation may have an angular offset from the longitudinal axis of between 5° and 20°. In particular, the fin 25 pivots between the inactive position in which the direction of elongation of the fin body 27 is transverse to the longitudinal axis and an active position in which the direction of elongation of the fin body 27 is substantially parallel to the longitudinal axis X. The rotation of the root 26 is made possible by the difference in cross-section between the base 29 and the third recess portion 45. As the third portion 45 has larger dimensions (angular sector of each part) than the base, the latter can pivot easily about the axis of revolution, in the plane of the bottom 45a. This rotation is also facilitated by, on the one hand, the rod 31, which acts as a pivot and is housed in at least one central area of the complementary-shaped recess 28 and, on the other hand, the platform 30 housed in the first portion 42 of the recess by complementary shape. Similarly, since the platform 30, the rod 31 and the base 29 are all in one-part, the whole assembly pivots around the axis of revolution.

The angle of rotation of the root is between 40° and 60°. The rotation of the root 26 is limited by at least one abutment. Alternatively, or additionally, the rotation of the root 26 is limited by the blocking means 37, in particular when the locking element is housed in one of the first and second grooves 50, 51 or in the retaining element 39. In this example, the abutment is formed by one of the abutment surfaces 47a of the third recess portion 45 as shown in FIG. 10. FIG. 10 shows the fin 25 in its active position. The abutment surface 33c of the first lug is in plane/planar contact with the panel 47a of the first part of the third portion 45 and the abutment surface 33d is in plane/planar contact with the panel 47b of the second part of the third portion 45. If rotation is limited by the blocking means, the abutment surfaces 33c, 33d may be at a distance from the panels 47a, 47b of the recess 28.

Following the rotation, the locking element is housed in the housing (forming the retaining element 39) of the third portion 45 provided for this purpose. When the root rotates, the ball comes into contact with the curvilinear partition of the third recess portion 45, the radius of which is substantially equal to the radius of a lug, which pushes the ball into the cavity 40. Once the ball is positioned opposite the housing (each lug is in abutment against a panel of the third portion), the ball is returned to its unlocking position by the spring and is introduced into the housing to lock the root 26 of the fin 25 in the corresponding recess 28. We understand that simply rotating the fin 25 enables it to be locked quickly and effectively in the recess 28 and on the annular wall 23.

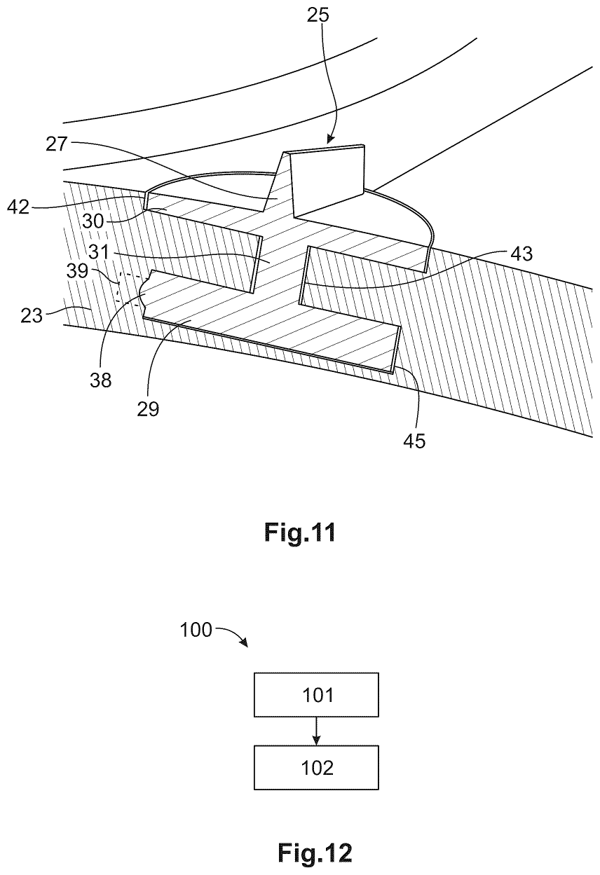

FIG. 11 shows the fin 25 removably fixed in the annular wall 23 with the ball carried by the root 26 housed in the recess 28 and the fin body 27 oriented substantially along the longitudinal axis.

In this way, the configurations of the root 26 of the fin 25 and of the recess 28 allow both to precisely position, quickly and efficiently the fin 25 in the annular wall 23 of the stator member while ensuring sealing in the wall and facilitating its replacement if it is damaged by wear or breakage, or to adapt the shape of the fin body according to a mission. Simply access the stator member from upstream or downstream to change/mount a fin. Furthermore, in the case of an annular wall sector, the installation of the fin between two adjacent stator vanes 20, 20′ does not hinder the sealing of the annular wall 23 and can be installed independently of the connection area between two annular wall sectors.

1. A stator member of a turbine engine of an aircraft, extending around a longitudinal axis, the stator member comprising:
at least one first stator vane; and
at least one second stator vane circumferentially adjacent to the first stator vane, the first and second stator vanes each comprising a blade extending radially from an annular wall centered on the longitudinal axis, the stator member comprising a fin arranged circumferentially between the first and second stator vanes,
wherein the annular wall comprises a recess of predetermined shape formed in a thickness of the annular wall, the recess open onto a radially external surface of the annular wall and spaced from the upstream and downstream edges of the annular wall, and
wherein the fin comprises:
a root complementary in shape to the recess and configured to be removably arranged in the recess; and
a fin body which extends radially from the root and which is elongated in a direction substantially parallel to the longitudinal axis.

2. The stator member according to claim 1, wherein the root extends along an axis of revolution and comprises a base and a separate platform connected by a rod along the axis of revolution.

3. The stator member according to claim 2, wherein the base has two lugs of identical shape arranged on either side of the rod in a plane perpendicular to the axis of revolution.

4. The stator member according to claim 1, wherein the fin is made from a material, or is formed from one-part pieces and subsequently assembled.

5. The stator member according to claim 2, wherein the recess comprises three portions configured to receive, respectively, one of the elements forming the root.

6. The stator member according to claim 2, wherein the recess comprises a first portion having a shape corresponding to that of the platform, the platform having an external surface having a surface continuity with the radially external surface of the annular wall.

7. The stator member according to claim 1, wherein the recess comprises a second portion and a third portion each having a shape similar to that of the base, the third portion having at least one dimension greater than that of the second portion and of the base.

8. The stator member according to claim 1, wherein the fin comprises blocking means for blocking the root in the recess.

9. The stator member according to claim 1, wherein the blocking means comprise a locking element arranged in a cavity of the base, the locking element being configured to occupy a locking position and an unlocking position, and an element for retaining the locking element in its locking position which is arranged in the recess.

10. The stator member according to claim 9, wherein the blocking means comprise a return element mounted in the cavity and configured to continuously urge the locking element towards the locking position.

11. The stator member according to claim 9, wherein the recess comprises at least one groove configured to receive at least part of the locking element in the unlocking position.

12. A turbine engine for an aircraft, comprising at least one stator member according to claim 1.

13. A method of mounting at least one fin in a stator member according to claim 1, the method comprising
positioning the root of the fin by complementary shape in the recess and in such a way that the direction of elongation of the fin body is transverse to the longitudinal axis; and
rotating the root of the fin about the axis of revolution in the recess so as to orientate the direction of elongation of the fin body substantially parallel to the longitudinal axis.
